(19) United States
(12) Patent Application Publication
(10) Pub. No.: US 2021/0362159 A1
(43) Pub. Date: Nov. 25, 2021

(54) MICROFLUIDIC CHIP

(71) Applicant: SHENZHEN BIORAIN BIOTECHNOLOGY CO., LTD., Shenzhen, Guangdong (CN)

(72) Inventors: Linfen YU, Shenzhen (CN); Wei YANG, Shenzhen (CN)

(73) Assignee: SHENZHEN BIORAIN BIOTECHNOLOGY CO., LTD., Shenzhen, Guangdong (CN)

(21) Appl. No.: 17/277,935

(22) PCT Filed: Nov. 23, 2018
(86) PCT No.: PCT/CN2018/117220

§ 371 Date: Mar. 19, 2021

(30) Foreign Application Priority Data
Oct. 23, 2018 (CN) 201811237864.X

(51) Int. Cl. B01L 3/00

(52) U.S. Cl. CPC B01L 3/502784; B01L 2300/1805; B01L 2300/0627; B01L 2200/027

(57) ABSTRACT

A microfluidic chip includes a chip upper layer, a chip lower layer, a sealing layer, and a droplet generation area, a droplet storage area, a droplet detection area and a waste liquid collection area that are provided on the microfluidic chip and that are communicated to each other through a channel. The droplet generation area is used for producing tens of thousands to millions of droplets by passing a sample phase through a continuous phase, after the droplets enter the droplet storage area for undergoing a PCR reaction, the droplet detection area is used for the optical detection of the droplet having undergone the PCR reaction, and the waste liquid collection area is used for collecting and storing the droplets and the continuous phase after detection.

### TECHNICAL FIELD

The application relates to the technical field of digital PCR, and, in particular, to a microfluidic chip.

### BACKGROUND ART

Existing droplet digital PCR technical route employs droplet generation, wherein PCR reaction and droplet detection are performed respectively on different instruments. This technical route may lead to tedious operation steps, non-closed samples and out of compliance with requirements for clinical diagnosis and analysis; and samples or chips need to be transferred manually between different instruments, increasing the overall operation time and cost, and restricting the widespread application of the technology.

### BRIEF SUMMARY OF THE DISCLOSURE

The application is to provide a microfluidic chip for implementing the full flow process including droplet generation, droplet storage, temperature control, PCR reaction, droplet detection, waste liquid treatment and the like.

The microfluidic chip described in the application includes a chip upper layer, a chip lower layer, a sealing layer, and a droplet generation area, a droplet storage area, a droplet detection area and a waste liquid collection area that are provided on the microsluidic chip, wherein the droplet generation area, the droplet storage area, the droplet detection area and the waste liquid collection area are communicated to each other through a channel.

The droplet generation area is used for producing tens of thousands to millions of droplets by passing a sample phase through a continuous phase, after the droplets enter the droplet storage area for undergoing a PCR reaction, the droplet detection area is used for the optical detection of the droplet having undergone the PCR reaction, and the waste liquid collection area is used for collecting and storing the droplets and the continuous phase after detection.

Wherein the chip upper layer is provided with a sample injection hole, a generation continuous phase injection hole, a detection continuous phase injection hole and a waste liquid discharge hole penetrating through the top and bottom surfaces of the chip upper layer, the top surface of the chip upper layer is provided with a sample pool communicated with the sample injection hole, a generation continuous phase pool communicated with the generation continuous phase injection hole, a detection continuous phase pool communicated with the detection continuous phase injection hole and a waste liquid pool communicated with the waste liquid discharge hole; and the chip lower layer is provided with a droplet transfer hole and a droplet discharge hole penetrating through the top and bottom surfaces of the chip lower layer.

Wherein the bottom surface of the chip upper layer is attached together with the top surface of the chip lower layer, and the bottom surface of the chip lower layer is attached together with the top surface of the sealing layer;

The droplet storage area is provided on the bottom surface of the chip lower layer, and the droplet generation area is provided on any one of the bottom surface of the chip upper layer, the top surface of the chip lower layer and the bottom surface of the chip lower layer, the droplet detection area and the waste liquid collection area are provided on the bottom surface of the chip upper layer or the top surface of the chip lower layer.

Wherein the microfluidic chip has a plurality of groups of droplet generation areas, droplet storage areas, droplet detection areas and waste liquid collection areas, which are independently arranged side by side and which correspond to a plurality of samples, each of groups of droplet generation areas, droplet storage areas, droplet detection areas and waste liquid collection areas form a full flow processing path of one sample, the microfluidic chip can independently perform droplet generation, droplet storage, temperature control and PCR reaction, droplet detection and waste liquid collection on the plurality of samples.

Wherein the droplet generation area includes a generation continuous phase inlet, a generation continuous phase channel communicated with the generation continuous phase inlet, a sample inlet and a sample phase channel communicated with the sample inlet, the generation continuous phase inlet is communicated with the generation continuous phase injection hole, the sample inlet is communicated with the sample injection hole, the sample phase channel is connected to at least one of the sample phase limb channels, each of the sample phase limb channels is connected to the generation continuous phase channel through a bell mouth;

The droplet is generated at the bell mouth and enters the generation continuous phase channel, and is driven to the end of the droplet generation area by the generation continuous phase.

Wherein in the thickness direction of the microfluidic chip, the depth size of the generation continuous phase channel is larger than or equal to 5 times the depth size of the bell mouth, the bell mouth is identical in size to the sample phase limb channel.

Wherein the droplet storage area includes a droplet storage slot, the droplet storage slot has the droplet transfer hole and the droplet discharge hole, which is communicated with the droplet detection area, extending therethrough, the droplet storage slot includes a dome face and an inner wall, the dome face is a dome-like design, the top of the dome is communicated with the droplet discharge hole, and the bottom of the inner wall is communicated with the droplet transfer hole.

Wherein the droplet detection area includes a detection continuous phase inlet, a detection continuous phase channel communicated with the detection continuous phase inlet, a droplet inlet, a droplet channel communicated with the droplet inlet, and a detection channel, the detection continuous phase inlet being communicated with the detection continuous phase injection hole, the droplet inlet being communicated with the droplet discharge hole; and the waste liquid collection area includes a waste liquid channel corresponding to the detection channel and a waste liquid outlet communicated with the waste liquid channel;

The detection continuous phase channel connects the detection continuous phase inlet to the detection channel, the droplet channel connects the droplet inlet to the detection channel, the detection continuous phase channel intersects the droplet channel and the detection channel at the same point, and the detection channel is communicated with the waste liquid channel.

Wherein when the droplet generation area is provided on the bottom surface of the chip upper layer or the top surface of the chip lower layer, the chip lower layer is provided with a droplet transfer channel communicated with the droplet transfer hole, and the droplet transfer channel is communicated with the droplet transfer hole and the droplet storage slot.

Wherein when the droplet generation area is provided on the bottom surface of the chip lower layer, the end of the droplet generation area is directly communicated with the droplet storage area, while the chip lower layer is provided with a sample injection hole communicated with the sample inlet and a generation continuous phase injection hole communicated with the generation continuous phase inlet;

The sample injection hole and the generation continuous phase injection hole penetrate through the top and bottom surfaces of the chip lower layer, and are communicated respectively with the sample injection hole and the generation continuous phase injection hole of the chip upper layer.

Wherein filtering areas are provided between the sample inlet and the sample phase channel, between the generation continuous phase inlet and the generation continuous phase channel, and between the detection continuous phase inlet and the detection continuous phase channel.

Wherein the sealing layer has the effect of sealing the bottom surface of the chip lower layer and transferring heat from/to the droplet storage area.

Wherein the droplet storage area includes a seal ring and a PCR tube. The bottom surface of the sealing layer is provided with an installation slot for the PCR tube, the installation slot for the PCR tube includes a dome face, a sealing face and an inner wall, and a droplet entry hole and a droplet discharge hole that penetrate through the sealing layer are provided within the extent of the dome face. One end of the droplet transfer channel is connected to the droplet transfer hole, the other end is communicated with the droplet entry hole, and the droplet discharge hole is communicated with the droplet discharge hole of the chip lower layer. The sealing ring and the PCR tube are installed between inner walls of the installation slot for the PCR tube, and the sealing face and the PCR tube are sealed from each other by the sealing ring.

The microfluidic chip provided by the application will be used for implementing the full flow process including droplet generation, droplet storage, temperature control, PCR reaction, droplet detection, waste liquid treatment and the like. This flow does not need to transfer samples manually, samples are hermetically closed from each other independently, implementing an automatic process for sample input and experiment result output with a highly integration of the microfluidic chip, and it is able to simplify the operation process, reduce the difficulty of operation and improve operation efficiency by transferring droplets autonomously among respective areas.

### BRIEF DESCRIPTION OF DRAWINGS

Accompanying drawings that are in conjunction with the description of embodiments will be briefly described below for ease and clarity of the explanation of technical solutions according to the application, it is readily apparent that accompanying drawings in the following description are only some of embodiments of the application, and those of ordinary skill in the art will envisage other accompanying drawing on the basis of these accompanying drawing without any creative effort.

FIG. 1 is a schematic view of a first embodiment of the microfluidic chip according to the application.

FIG. 2 is a plan schematic view of the microfluidic chip.

FIG. 3 is a cut-away schematic view of the full flow processing path of a single sample for the microfluidic chip.

FIG. 4 is a schematic view of a bottom surface of a chip upper layer of the microfluidic chip shown in FIG. 1.

FIG. 5 is a partially enlarged schematic view of a droplet generation area of the microfluidic chip shown in FIG. 1.

FIG. 6 is a schematic view of a chip lower layer of the microfluidic chip shown in FIG. 1.

FIG. 7 is a partially enlarged schematic view and a cut-away schematic view of a chip lower layer of the microfluidic chip shown in FIG. 1.

FIG. 8 is a partially enlarged schematic view of a droplet detection area of the microfluidic chip shown in FIG. 1.

FIG. 9 is a schematic view of the full flow processing path of a single sample for a second embodiment of the microfluidic chip according to the application.

FIG. 10 is a schematic view of a chip lower layer of the second embodiment of the microfluidic chip shown in FIG. 9.

FIG. 11 is a schematic view of a sealing layer of the second embodiment of the microfluidic chip shown in FIG. 9.

FIG. 12 is a schematic view of a sealing ring of the second embodiment of the microfluidic chip shown in FIG. 9.

FIG. 13 is a schematic view of a chip lower layer of a third embodiment of the microfluidic chip according to the application.

FIG. 14 is a schematic view of a chip lower layer of a fourth embodiment of the microfluidic chip according to the application.

FIG. 15 is a schematic view of a droplet generation area of the fourth embodiment of the microfluidic chip shown in FIG. 14.

### DETAILED DESCRIPTION OF EMBODIMENTS

Technical solutions according to embodiments of the present application will clearly and fully described below in conjunction with accompanying drawings thereof, it is readily apparent that the described embodiments are some, but not all, of embodiments of the application. According to embodiments of the application, all of other embodiments that are envisaged by those of ordinary skill in the art without any creative effort will fall within the scope of the claimed application.

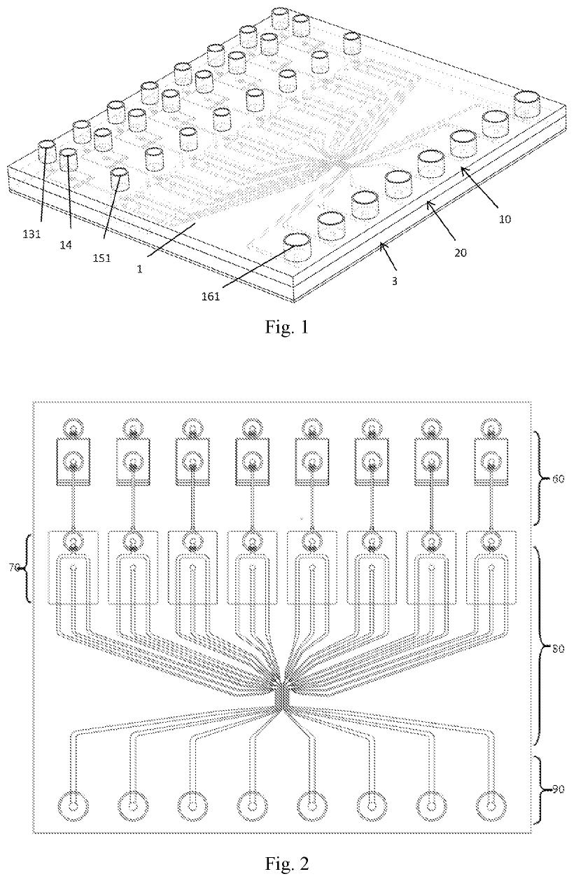

Referring not to FIGS. 1-8, which are shown in perspective to be able to see the internal structure clearly. The application is to provide a microfluidic chip for implementing the full flow process including droplet generation, droplet storage, temperature control, PCR reaction, droplet detection and waste liquid collection, wherein the droplet generation is done in the droplet generation area 60, the droplet storage, temperature control and PCR reaction are done in the droplet storage area 70, the droplet detection is done in the droplet detection area 80, and the waste liquid collection is done in the waste liquid collection area 90. The microfluidic chip includes a chip upper layer 10, a chip lower layer 20, a sealing layer 30, and a droplet generation area 60, a droplet storage area 70, a droplet detection area 80 and a waste liquid collection area 90 that are provided on the microfluidic chip, wherein the droplet generation area 60, the droplet storage area 70, the droplet detection area 80 and the waste liquid collection area 90 are communicated to each other through a channel.

The droplet generation area 60 is used for producing tens of thousands to millions of droplets by passing a sample phase through a continuous phase, after the droplets enter the droplet storage area 70 for undergoing a PCR reaction, the droplet detection area 80 is used for the optical detection of the droplet having undergone the PCR reaction, and the waste liquid collection area 90 is used for collecting and storing the droplets and the continuous phase after detection.

The microfluidic chip of the embodiment has a plurality of groups of droplet generation areas 60, droplet storage areas 70, droplet detection areas 80 and waste liquid collection areas 90, which are independently arranged side by side and which correspond to a plurality of samples, each of groups of droplet generation areas 60, droplet storage areas 70, droplet detection areas 80 and waste liquid collection areas 90 form a full flow processing path of one sample, the microfluidic chip can independently perform droplet generation, droplet storage, temperature control and PCR reaction, droplet detection and waste liquid collection on the plurality of samples. The following description will mainly clarify the full flow processing path of a single sample, it is readily apparent that the structural principle of the full flow processing path for each of samples are is the same.

In the embodiment, the chip upper layer 10 includes the top surface 11 and the bottom surface 12, the chip lower layer 20 includes the top surface 21 and the bottom surface 22, and the sealing layer 30 includes the top surface 31 and the bottom surface 32, the bottom surface 12 of the chip upper layer 10 is attached together with the top surface 21 of the chip lower layer 20, and the bottom surface 22 of the chip lower layer 20 is attached together with the top surface 31 of the sealing layer 30. The attaching is performed by adhesive joining, welding, bonding, etc., in order to ensure that the attaching is firm and tight.

The droplet storage area 70 is provided on the bottom surface 12 of the chip lower layer 10, and the droplet generation area is provided on any one of the bottom surface 12 of the chip upper layer 10, the top surface 21 of the chip lower layer 20 and the bottom surface 22 of the chip lower layer 20, the droplet detection area 80 and the waste liquid collection area 90 are provided on the bottom surface 12 of the chip upper layer 10 or the top surface 21 of the chip lower layer 20.

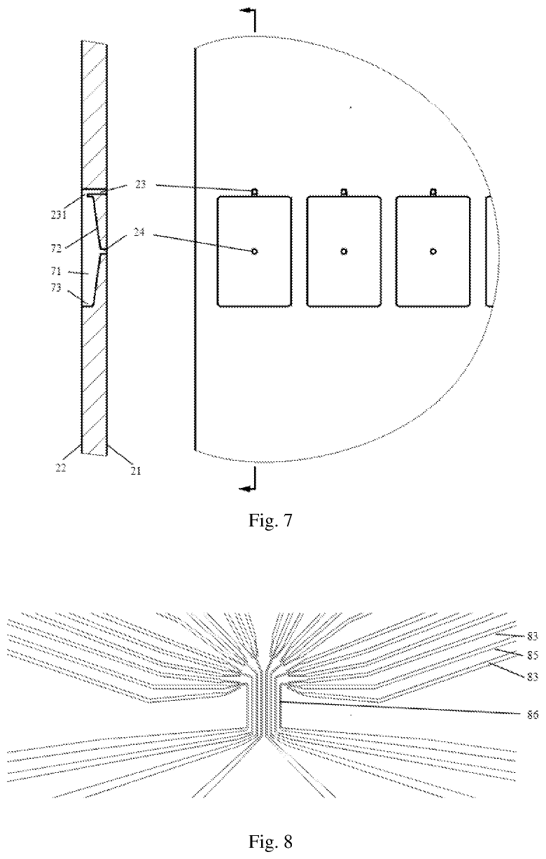

As shown in FIG. 4 and FIG. 7, in a first embodiment of the microfluidic chip according to the application, the droplet generation area 60 is provided on the bottom surface 12 of the chip upper layer 10 near one end. The droplet detection area 80 and the waste liquid collection area 90 are provided on the bottom surface 12 of the chip upper layer 10 at one end far away from the droplet generation area 60, and the droplet storage area 70 is provided on the bottom surface 22 of the chip lower layer 20.

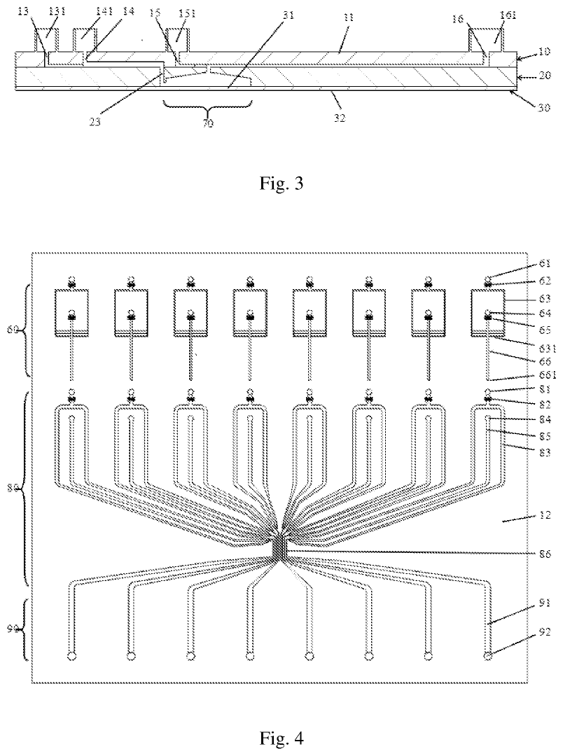

As shown in FIG. 1 and FIG. 3, the chip upper layer 10 is provided with a sample injection hole 13, a generation continuous phase injection hole 14, a detection continuous phase injection hole 15 and a waste liquie discharge hole 16 that penetrate through the top and bottom surfaces of the chip upper layer 10. The top surface 11 of the chip upper layer 10 is provided with a sample pool 131 communicated with the sample injection hole 13, a generation continuous phase pool 141 communicated with the generation continuous phase injection hole 14, a detection continuous phase pool 151 communicated with the detection continuous phase injection hole 15 and a waste liquid pool 161 communicated with the waste liquid discharge hole 16; and the chip lower layer 20 is provided with a droplet transfer hole 23 and a droplet discharge hole 24 penetrating through the top and bottom surfaces of the chip lower layer 20, and a droplet transfer channel 231 communicated with the droplet transfer hole 23.

As shown in FIG. 4-6, the droplet generation area 60 includes generation continuous phase inlets 64, generation continuous phase channels 66 communicated with the generation continuous phase inlets 64, sample inlets 61 and sample phase channels 63 communicated with the sample inlets 61, the generation continuous phase inlets 64 are communicated with the generation continuous phase injection hole 14, the sample inlets 61 are communicated with the sample injection hole 13, the sample phase channels 63 are connected to at least one of the sample phase limb channels 631, each of the sample phase limb channels 631 is connected to the generation continuous phase channels 66 through a bell mouth 632; the droplet is generated at the bell mouth 632 and enters the generation continuous phase channel 66, and is driven to the end 661 of the droplet generation area 60 by the generation continuous phase.

In the thickness direction of the microfluidic chip, the depth size of the generation continuous phase channel 66 is larger than or equal to 2 times the depth size of the bell mouth 632, the bell mouth 632 is identical in size to the sample phase limb channel 631.

In the embodiment, the number of the droplet generation areas 60 is described as 8 by way of example, and the numbers of the sample inlets 61, the sample phase channels 63, the generation continuous phase inlets 64 and the generation continuous phase channels 66 are 8 respectively. The sample inlets 61, the sample phase channels, the generation continuous phase inlets 64 and the generation continuous phase channels 66 are all recessed in the bottom surface 12 of the chip upper layer 10 and are encapsulated by the chip lower layer 20. Wherein 8 sample inlets 61 are arranged in a row, 8 sample generation continuous phase inlets 64 are arranged in a row and are arranged side by side with the row where the sample inlets 61 are located. The sample inlets 61 are located on the side far away from the droplet detection areas with respect to the generation continuous phase inlets 64.

Filtering areas are provided between the sample inlet 61 and the sample phase channel 63 and between the generation continuous phase inlet 64 and the generation continuous phase channel 66. Specifically, the sample filtering area 62 is provided between the sample inlet 61 and the sample phase channel 63, and the sample filtering area 62 includes cavities that are located on one side of the sample inlet 61 and that are communicated with the sample inlet 61, and a plurality of microcolumns 621 that are arranged in an array within cavities. The generation continuous phase filtering area 65 is provided between the generation continuous phase inlet 64 and the generation continuous phase channel 66, and the generation continuous phase filtering area 65 includes cavities that are located on one side of the generation continuous phase inlet 64 and that are communicated with the generation continuous phase inlet 64, and a plurality of microcolumns 651 that are arranged in an array within cavities. The distances between the plurality of microcolumns 621 and microcolumns 651 are 10-100 micrometers and function to intercept impurities.

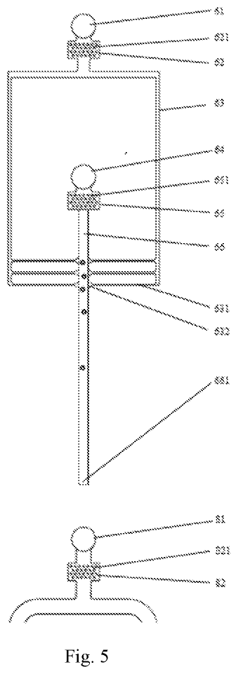

As shown in FIG. 5, the generation continuous phase enters from the generation continuous phase inlet 64, through the generation continuous phase filtering area 65, and enters into and fills up the generation continuous phase channel 66. The sample phase channel 63 is a bilaterally symmetrical structure, the sample phase enters from the sample inlet 61, through the sample filtering area 62, and into both sides of the sample phase channel 63 in respective one of both branches. The sample phase channel 63 and the generation continuous phase channel 66 are connected to each other through the sample phase limb channel 631, and the sample phase limb channel 631 are connected to each other through the bell mouth 632. Specifically, when the number of the sample phase limb channel 631 is more than one, the plurality of sample phase limb channel 631 are connected to symmetrical sides of the generation continuous phase channel 66. In the embodiment, 6 sample phase limb channels 631 are shown by way of example, the 6 sample phase limb channels 631 are located on symmetrical sides of the generation continuous phase channel 66 and are communicated with the sample phase channel 61. The number of the sample phase limb channels 631 is 1-100, the more the number of the sample phase limb channels 631 is, the higher the efficiency of the droplet generation. The bell mouth 632 is a “<” shape with bilateral symmetrical openings or a “Z” shape with a single bevel opening. The sample phase is broken into individual droplets due to the action of pressure difference and surface tension during the process of sample phase entering the generation continuous phase channel 66 through the bell mouth 632, the droplets are encased in the generation continuous phase, and then the droplets are driven in the generation continuous phase channel 66 toward the end 661 of the droplet generation area 60 by the flowing generation continuous phase.

Further, the depth size of the generation continuous phase channel 66 is larger than or equal to 2 times the depth size of the sample phase limb channel 631 and that of the bell mouth 632. The sample phase limb channel 631 has a width of 10-200 micrometers and a depth of 2-100 micrometers, and the ratio of the width to the depth of the sample phase limb channel 631 is larger than 1. The generation continuous phase channel 66 has a width of 10-2000 micrometers and a depth of 10-500 micrometers.

The droplet storage area 70 is provided on the bottom surface 22 of the chip lower layer 20, and is staggered with the position of the droplet generation area 60. The sample injection hole 13 and the generation continuous phase injection hole 14 penetrate through the top surface 11 and the bottom surface 12 of the chip upper layer 10, and is communicated with the sample inlet 61 and the generation continuous phase inlet 64, so as to inject the sample phase and continuous phase. The generation continuous phase channel 66 is located far away from one end of the generation continuous phase inlet 64 and is communicated with the droplet transfer hole 23, and the droplet transfer hole 23 is used to be communicated with the droplet storage area 70.

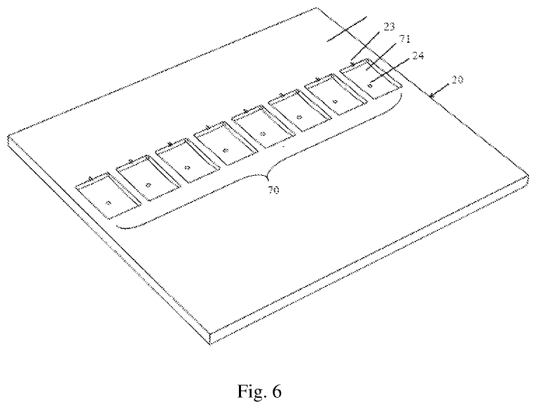

As shown in FIG. 6 and FIG. 7, in the embodiment, each of the droplet storage areas 70 includes droplet storage slots 71, each of the droplet storage slots 71 has the droplet transfer hole 23 and the droplet discharge hole 24, which is communicated with the droplet detection area 80, extending therethrough, the droplet storage slot 71 includes a dome face 72 and an inner wall 73, the dome face 72 is a dome-like design, the top of the dome is communicated with the droplet discharge hole 24, and the bottom of the inner wall 73 is communicated with the droplet transfer hole 23. Specifically, the droplet transfer hole 23 is communicated with the bottom of the inner wall 73 of the droplet storage slot 71 through the droplet transfer channel 231, the droplet storage slot 71 is a space enclosed by the dome face 72 and the inner wall 73.

The number of the droplet storage areas 70 is described as 8 by way of example, the numbers of the droplet storage slots 71, the droplet transfer holes 23 and the droplet discharge holes 24 are 8 respectively, the 8 droplet storage areas 70 include 8 droplet storage slots 71 arranged in the same row, and the droplet transfer hole 23 and the droplet discharge hole 24 of each of the droplet storage areas 70 are spaced apart from each other. The microfluidic chip of the application is in horizontality during application, so the dome face 72 is in fact the top surface of the droplet storage slot 71. The dome face 72 is a conical face, its intersection with the droplet discharge hole 24 is the highest point, since the droplet is less than the detection continuous phase in density, the droplet within the storage slot 71 floats toward the top closer to the dome face 72, and the shape of the dome face 72 enables the droplet to float and concentrate to the droplet discharge hole 24 in favor of quick and thorough discharging of droplets.

Referring now to FIG. 3, specifically, the droplet generation area 60 generates droplets, through the end 661 of the droplet generation area 60, each of the droplets enters the droplet storage slot 71 through the droplet transfer hole 23 communicated with the droplet storage area 70 and the droplet transfer channel 231 communicated with the droplet transfer hole 23 and the droplet storage slot 71, undergoes the PCR reaction within the droplet storage slot 71, and after the PCR reaction is done, the droplet enters the droplet detection area 80 through the droplet discharge hole 24 of the droplet storage slot 71. The good sealing of the droplet storage slot 71 will ensure the storage and circulation of droplets.

In the embodiment, the bottom surface 22 of the chip lower layer is attached together with the top surface 31 of the sealing layer 30, causing in the closed droplet storage space formed by the droplet storage area 70. The sealing layer 30 has the effect of sealing the droplet storage area 70 on the bottom surface 22 of the chip lower layer 20 and transferring heat from/to the droplet storage area 70. The thickness of the sealing layer 30 is 0.1-5 millimeters, to make the heat conduction during the PCR reaction more rapid, the sealing layer 30 should be as thin as possible.

Referring now to FIG. 4, the droplet detection area 80 includes a detection continuous phase inlet 81, a detection continuous phase channel 83 communicated with the detection continuous phase inlet 81, a droplet inlet 84, a droplet channel 85 communicated with the droplet inlet 84, and a detection channel 86, the detection continuous phase inlet 81 being communicated with the detection continuous phase injection hole 15, the droplet inlet 84 being communicated with the droplet discharge hole 24; and the waste liquid collection area 90 includes a waste liquid channel 91 corresponding to the detection channel 86 and a waste liquid outlet 92 communicated with the waste liquid channel 91;

The detection continuous phase channel 83 connects the detection continuous phase inlet 81 to the detection channel 86, the droplet channel 85 connects the droplet inlet 84 to the detection channel 86, the detection continuous phase channel 83 intersects the droplet channel 85 and the detection channel 86 at the same point, and the detection channel 86 is communicated with the waste liquid channel 91.

In the embodiment, the numbers of the droplet detection areas 80 and the waste liquid collection areas 90 are described as 8 respectively by way of example, the numbers of the detection continuous phase inlets 81, the detection continuous phase channels 83, the droplet inlets 84, the droplet channels 85, the detection channels 86, the waste liquid channels 91 and the waste liquid outlets 92 are 8 respectively, the droplet detection areas 80 and the waste liquid collection areas 90 are provided on the bottom surface 12 of the chip upper layer 10, and the detection continuous phase injection holes 15 and the waste liquid discharge holes 16 penetrate through the top surface 11 and the bottom surface 12 of the chip upper layer 10 and are communicated with the detection continuous phase inlets 81 and the waste liquid outlets 92. The droplet generation areas 60, the droplet detection areas 80 and the waste liquid collection areas 90 are arranged sequentially from one end of the bottom surface 12 of the chip upper layer 10 to other end. On the position corresponding to the droplet inlet 84 on the chip lower layer 20, the droplet transfer hole 23 is provided, the droplet inlet 84 is docked with the droplet transfer hole 23.

A filtering area is provided between the detection continuous phase inlet 81 and the detection continuous phase channel 83. Specifically, the detection continuous phase filtering area 82 is provided between the detection continuous phase inlet 81 and the detection continuous phase channel 83, and the detection continuous phase filtering area 82 includes cavities that are located on one side of the detection continuous phase inlet 81 and that are communicated with the detection continuous phase inlet 81, and a plurality of microcolumns 821 that are arranged in an array within cavities. The distances between the plurality of microcolumns 821 are 10-100 micrometers and function to intercept impurities.

As shown in FIG. 4, the detection continuous phase channel 83 is a structure with both sides bifurcated, branches on both sides intersect with the droplet channel 85 and the detection channel 86 at the same point. The detection continuous phase enters into the detection continuous phase filtering area 82 from the detection continuous phase inlet 81, is filtered by the microcolumn 821, enters into the detection continuous phase channel 83 and then are split to both sides, while the droplet enters the droplet channel 85 from the droplet inlet 84, the droplet and the detection continuous phase enter the detection channel 86 at the same time, and the distance between droplets becomes larger due to squeezing of the detection continuous phase, favoring the detection of the droplet by other optical detection systems.

As shown in FIG. 8, in the embodiment, the 8 detection channels 86 spaced apart from each other in parallel are grouped together side by side, thus favoring detection by other optical detection systems. The detection channel 86 is communicated with the waste liquid channel 91, the detected droplet and detection continuous phase flow to the waste liquid outlet 92 through the waste liquid channel 91.

Specifically, the detection continuous phase inlet 81 is located on one side closer to the droplet generation area 60, and the droplet inlet 84 is located on one side far away from the droplet generation area 60. The detection continuous phase channel 83 are bent in two directions and then extend along both sides of the droplet channel 85 until converging on the top of the detection channel 86. The detection continuous phase channel 83 is communicated with the detection continuous phase inlet 81 and the detection channel 86, and the detection continuous phase channel 83 intersects and is communicated with the droplet channel 85 from two directions at an angle. The droplet channel 85 is connected to the droplet inlet 84 and the detection channel 86, and together with the detection continuous phase channel 83, converges at the same position of the detection channel 86.

In the embodiment, the detection continuous phase channel 83 corresponding to the same detection continuous phase inlet 81 and the droplet channel 85 corresponding to the droplet inlet 84 corresponding to the detection continuous phase inlet 81 extend over a distance and then are obliquely gathered together in the middle of the chip, and finally converge on the top of the detection channel 86, and the 8 detection channels 86 are spaced apart from each other in parallel, while the waste liquid channel 91 extends outward over a distance from the other side of the detection channel 86, and then extends to the waste liquid outlet 91. The sample injection hole 13, the generation continuous phase injection hole 14, the detection continuous phase injection hole 15 and the waste liquid discharge hole 16 on the chip upper layer 10 are respectively aligned with the sample inlet 61, the generation continuous phase inlet 64 of the droplet generation area 60, the detection continuous phase inlet 81 and the waste liquid outlet 92. The end 661 of the droplet generation area is aligned with the droplet transfer hole 23, and the droplet discharge hole 24 is aligned with the droplet inlet 84 of the droplet detection area 80.

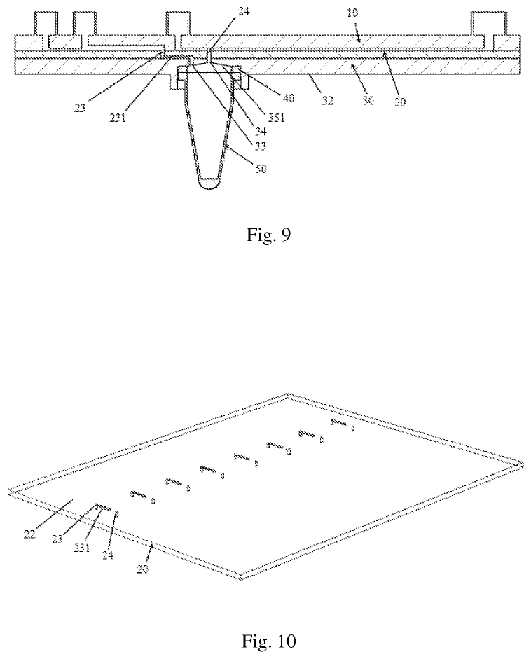

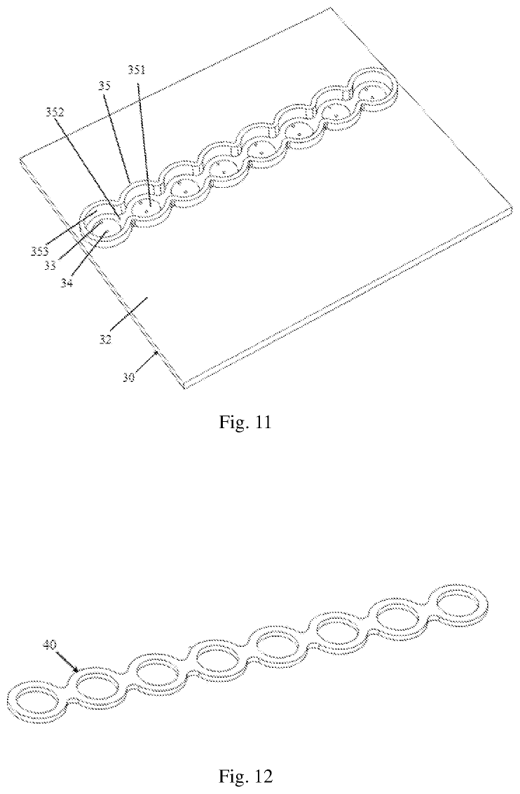

As shown in FIG. 9-12, in a second embodiment of the application, based on the solutions of the first embodiment, the container for droplet storage and PCR reaction is changed to a PCR tube 50. Generally similar to the scheme of the first embodiment, the microfluidic chip of the embodiment includes a chip upper layer 10, a chip lower layer 20 and a sealing layer 30, except for the chip layer 20 and the sealing layer 30 that are different from the first embodiment, specifically, the droplet storage area of the embodiment includes a sealing ring 40 and a PCR tube 50.

As shown in FIG. 10-12, the chip lower layer 20 is provided with a droplet transfer hole 23 and a droplet discharge hole 24 penetrating through the top and bottom surfaces, the bottom surface 22 is provided with a droplet transfer channel 231, and one end of the droplet transfer channel 231 is connected to the droplet transfer hole 23. The bottom surface 32 of the sealing layer 30 is provided with an installation slot 35 for the PCR tube, the installation slot 35 for the PCR tube includes a dome face 351, a sealing face 352 and an inner wall 353, and a droplet entry hole 33 and a droplet discharge hole 34 that penetrate through the sealing layer are provided within the extent of the dome face. One end of the droplet transfer channel 231 is connected to the droplet transfer hole 23, the other end is communicated with the droplet entry hole 33, and the droplet discharge hole 34 is communicated with the droplet discharge hole 24 of the chip lower layer 20. The sealing ring 40 and the PCR tube 50 are installed between inner walls 353 of the installation slot 35 for the PCR tube, and the sealing face 352 and the PCR tube 50 are sealed from each other by the sealing ring 49.

As shown in FIG. 9, the PCR tube 50 is installed in the installation slot 35 on the bottom surface 32 of the sealing layer 30, the inner wall 353 has the effect of position limiting and clamping the PCR tube 50, a sealing ring 40 is installed between the sealing face 352 and the PCR tube 50. The droplet transfer channel 231 is communicated with the droplet entry hole 33, and the droplet discharge hole 34 is aligned with the droplet discharge hole 24 of the chip lower layer 20. Identical to the first embodiment, the end 661 of the droplet generation area is aligned with the droplet transfer hole 23, and the droplet discharge hole 24 of the chip lower layer 20 is aligned with the droplet inlet 84 of the droplet detection area 80. The dome face 351 has the effect of quickly and thoroughly discharging droplet.

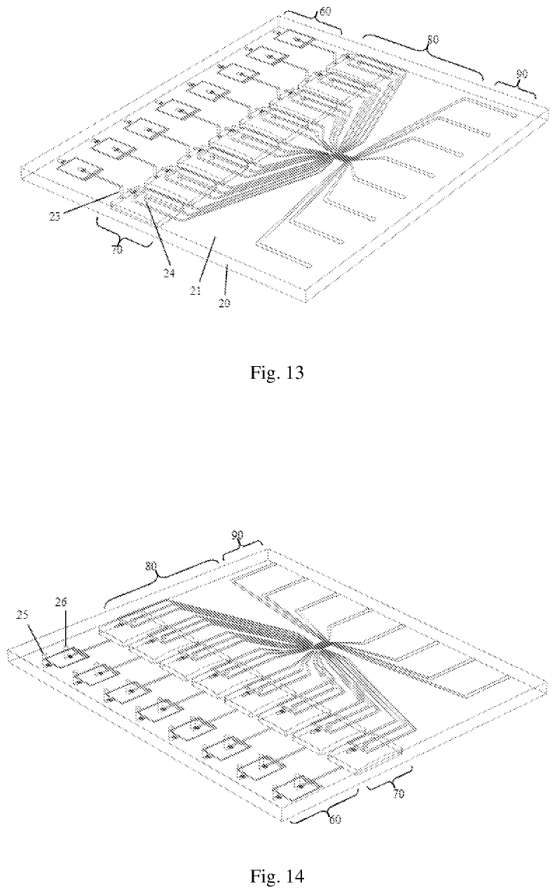

As shown in FIG. 13, in a third embodiment of the application, based on the solutions of the first embodiment, the droplet generation area 60, the droplet detection area 80 and the waste liquid collection area 90 are moved to the top surface 21 of the chip lower layer 20.

The chip lower layer 20 is provided with a drop transfer channel 231 communicated with the droplet transfer hole 23, and the droplet transfer channel 231 is communicated with the droplet transfer hole 23 and the droplet storage slot 71 of the droplet storage area 70. The end 661 of the droplet generation area 60 is aligned with the droplet transfer hole 23 of the chip lower layer, and the droplet discharge hole 24 of the chip lower layer 20 is aligned with the droplet inlet 84 of the droplet detection area 80.

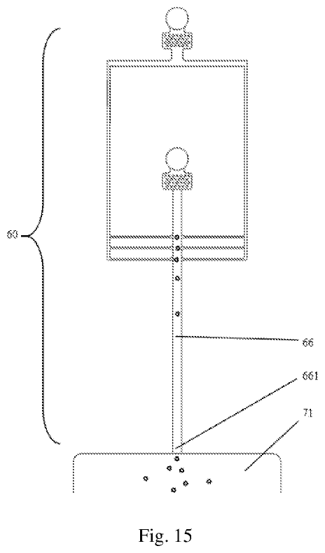

As shown in FIG. 14 and FIG. 15, in a fourth embodiment of the application, based on the solutions of the third embodiment, the droplet generation area 60 is moved to the bottom surface 22 of the chip lower layer 20, and 8 sample injection holes 25 and 8 generation continuous phase injection holes 26 are added. The sample injection hole 25 and the generation continuous phase injection hole 26 penetrate through the top surface 21 and the bottom surface 22 of the chip lower layer 20, and are communicated respectively with the sample injection hole 13 and the generation continuous phase injection hole 14 of the chip upper layer 10. The sample injection hole 25 and the generation continuous phase injection hole 26 are respectively aligned with the sample inlet 61 and the generation continuous phase inlet 64 of the droplet generation area 60. The end 661 of the droplet generation area 60 is communicated with the droplet storage slot 71, and the generated droplet directly enters the droplet storage slot 71 through the generation continuous phase channel 66 without a process of droplet transfer. The sealing layer 30 has the effect of sealing the droplet generation area 60 and the droplet storage area 70 on the bottom surface 22 of the chip lower layer 20 and transferring heat from/to the droplet storage area.

The microfluidic chip provided by the application is used for implementing the full flow process including droplet generation, droplet storage, temperature control, PCR reaction, droplet detection, waste liquid treatment and the like. A plurality of samples may be processed at the same time with a highly integration, and samples are hermetically closed from each other independently, the whole flow does not need to transfer samples manually, meeting the needs of automatic operation. In addition, it is able to simplify the operation process, reduce the difficulty of operation and improve operation efficiency by transferring droplets autonomously among respective areas.

Embodiments of the application are described in detail above, although principles and embodiments of the application are set forth by way of specific examples herein, the above description of embodiments is only used to facilitate the understanding of methods of the application and the core idea thereof; while other implementations that may be replaced with each other may be advised by those of ordinary skill in the art according to the idea of the application, without altering the essential spirit of the application. Thus content described in this specification should not be construed as limiting the application.

1-13. (canceled)

14. A microfluidic chip, wherein the microfluidic chip includes a chip upper layer, a chip lower layer, a sealing layer, and a droplet generation area, a droplet storage area, a droplet detection area and a waste liquid collection area that are provided on the microsluidic chip, wherein the droplet generation area, the droplet storage area, the droplet detection area and the waste liquid collection area are communicated to each other through a channel;
the droplet generation area is used for producing tens of thousands to millions of droplets by passing a sample phase through a continuous phase, after the droplets enter the droplet storage area for undergoing a PCR reaction, the droplet detection area is used for the optical detection of the droplet that have undergone the PCR reaction, and the waste liquid collection area is used for collecting and storing the droplets and the continuous phase after detection.

15. The microfluidic chip of claim 14, wherein the chip upper layer is provided with a sample injection hole, a generation continuous phase injection hole, a detection continuous phase injection hole and a waste liquid discharge hole penetrating through the top and bottom surfaces of the chip upper layer, the top surface of the chip upper layer is provided with a sample pool communicated with the sample injection hole, a generation continuous phase pool communicated with the generation continuous phase injection hole, a detection continuous phase pool communicated with the detection continuous phase injection hole and a waste liquid pool communicated with the waste liquid discharge hole;
the chip lower layer is provided with a droplet transfer hole and a droplet discharge hole penetrating through the top and bottom surfaces of the chip lower layer.

16. The microfluidic chip of claim 15, wherein the bottom surface of the chip upper layer is attached together with the top surface of the chip lower layer, and the bottom surface of the chip lower layer is attached together with the top surface of the sealing layer;
the droplet storage area is provided on the bottom surface of the chip lower layer, and the droplet generation area is provided on any one of the bottom surface of the chip upper layer, the top surface of the chip lower layer and the bottom surface of the chip lower layer, the droplet detection area and the waste liquid collection area are provided on the bottom surface of the chip upper layer or the top surface of the chip lower layer.

17. The microfluidic chip of claim 16, wherein the microfluidic chip has a plurality of groups of droplet generation areas, droplet storage areas, droplet detection areas and waste liquid collection areas, which are independently arranged side by side and which correspond to a plurality of samples, each of groups of droplet generation areas, droplet storage areas, droplet detection areas and waste liquid collection areas form a full flow processing path of one sample, the microfluidic chip can independently perform droplet generation, droplet storage, temperature control and PCR reaction, droplet detection and waste liquid collection on the plurality of samples.

18. The microfluidic chip of claim 17, wherein the droplet generation area includes a generation continuous phase inlet, a generation continuous phase channel communicated with the generation continuous phase inlet, a sample inlet and a sample phase channel communicated with the sample inlet, the generation continuous phase inlet is communicated with the generation continuous phase injection hole, the sample inlet is communicated with the sample injection hole, the sample phase channel is connected to at least one of the sample phase limb channels, each of the sample phase limb channels is connected to the generation continuous phase channel through a bell mouth;
the droplet is generated at the bell mouth and enters the generation continuous phase channel, and is driven to the end of the droplet generation area by the generation continuous phase.

19. The microfluidic chip of claim 18, wherein in the thickness direction of the microfluidic chip, the depth size of the generation continuous phase channel is larger than or equal to 5 times the depth size of the bell mouth, the bell mouth is identical in size to the sample phase limb channel.

20. The microfluidic chip of claim 17, wherein the droplet storage area includes a droplet storage slot, the droplet storage slot has the droplet transfer hole and the droplet discharge hole, which is communicated with the droplet detection area, extending therethrough, the droplet storage slot includes a dome face and an inner wall, the dome face is a dome-like design, the top of the dome is communicated with the droplet discharge hole, and the bottom of the inner wall is communicated with the droplet transfer hole.

21. The microfluidic chip of claim 17, wherein the droplet detection area includes a detection continuous phase inlet, a detection continuous phase channel communicated with the detection continuous phase inlet, a droplet inlet, a droplet channel communicated with the droplet inlet, and a detection channel, the detection continuous phase inlet being communicated with the detection continuous phase injection hole, the droplet inlet being communicated with the droplet discharge hole; and the waste liquid collection area includes a waste liquid channel corresponding to the detection channel and a waste liquid outlet communicated with the waste liquid channel;
the detection continuous phase channel connects the detection continuous phase inlet to the detection channel, the droplet channel connects the droplet inlet to the detection channel, the detection continuous phase channel intersects the droplet channel and the detection channel at the same point, and the detection channel is communicated with the waste liquid channel.

22. The microfluidic chip of claim 15, wherein when the droplet generation area is provided on the bottom surface of the chip upper layer or the top surface of the chip lower layer, the chip lower layer is provided with a droplet transfer channel communicated with the droplet transfer hole, and the droplet transfer channel is communicated with the droplet transfer hole and the droplet storage slot.

23. The microfluidic chip of claim 15, wherein when the droplet generation area is provided on the bottom surface of the chip lower layer, the end of the droplet generation area is directly communicated with the droplet storage area, and the chip lower layer is provided with a sample injection hole communicated with a sample inlet and a generation continuous phase injection hole communicated with a generation continuous phase inlet;
the sample injection hole and the generation continuous phase injection hole penetrate through the top and bottom surfaces of the chip lower layer, and are communicated respectively with the sample injection hole and the generation continuous phase injection hole of the chip upper layer.

24. The microfluidic chip of claim 18, wherein filtering areas are provided between a sample inlet and a sample phase channel, between a generation continuous phase inlet and a generation continuous phase channel, and between a detection continuous phase inlet and a detection continuous phase channel.

25. The microfluidic chip of claim 14, wherein the sealing layer has the effect of sealing the bottom surface of the chip lower layer and transferring heat from/to the droplet storage area.

26. The microfluidic chip of claim 14, wherein the droplet storage area includes a seal ring and a PCR tube, the bottom surface of the sealing layer is provided with an installation slot for the PCR tube, the installation slot for the PCR tube includes a dome face, a sealing face and an inner wall, and a droplet entry hole and a droplet discharge hole that penetrate through the sealing layer are provided within the extent of the dome face, one end of a droplet transfer channel is connected to a droplet transfer hole, the other end is communicated with the droplet entry hole, the droplet discharge hole is communicated with the droplet discharge hole of the chip lower layer, the sealing ring and the PCR tube are installed between inner walls of the installation slot for the PCR tube, and the sealing face and the PCR tube are sealed from each other by the sealing ring.

27. The microfluidic chip of claim 18, wherein when the droplet generation area is provided on the bottom surface of the chip upper layer or the top surface of the chip lower layer, the chip lower layer is provided with a droplet transfer channel communicated with the droplet transfer hole, and the droplet transfer channel is communicated with the droplet transfer hole and the droplet storage slot.

28. The microfluidic chip of claim 19, wherein when the droplet generation area is provided on the bottom surface of the chip upper layer or the top surface of the chip lower layer, the chip lower layer is provided with a droplet transfer channel communicated with the droplet transfer hole, and the droplet transfer channel is communicated with the droplet transfer hole and the droplet storage slot.

29. The microfluidic chip of claim 20, wherein when the droplet generation area is provided on the bottom surface of the chip upper layer or the top surface of the chip lower layer, the chip lower layer is provided with a droplet transfer channel communicated with the droplet transfer hole, and the droplet transfer channel is communicated with the droplet transfer hole and the droplet storage slot.

30. The microfluidic chip of claim 18, wherein when the droplet generation area is provided on the bottom surface of the chip lower layer, the end of the droplet generation area is directly communicated with the droplet storage area, and the chip lower layer is provided with a sample injection hole communicated with a sample inlet and a generation continuous phase injection hole communicated with a generation continuous phase inlet;
the sample injection hole and the generation continuous phase injection hole penetrate through the top and bottom surfaces of the chip lower layer, and are communicated respectively with the sample injection hole and the generation continuous phase injection hole of the chip upper layer.

31. The microfluidic chip of claim 19, wherein when the droplet generation area is provided on the bottom surface of the chip lower layer, the end of the droplet generation area is directly communicated with the droplet storage area, and the chip lower layer is provided with a sample injection hole communicated with a sample inlet and a generation continuous phase injection hole communicated with a generation continuous phase inlet;
the sample injection hole and the generation continuous phase injection hole penetrate through the top and bottom surfaces of the chip lower layer, and are communicated respectively with the sample injection hole and the generation continuous phase injection hole of the chip upper layer.

32. The microfluidic chip of claim 20, wherein when the droplet generation area is provided on the bottom surface of the chip lower layer, the end of the droplet generation area is directly communicated with the droplet storage area, and the chip lower layer is provided with a sample injection hole communicated with a sample inlet and a generation continuous phase injection hole communicated with a generation continuous phase inlet;
the sample injection hole and the generation continuous phase injection hole penetrate through the top and bottom surfaces of the chip lower layer, and are communicated respectively with the sample injection hole and the generation continuous phase injection hole of the chip upper layer.

33. The microfluidic chip of claim 18, wherein filtering areas are provided between a sample inlet and a sample phase channel, between a generation continuous phase inlet and a generation continuous phase channel, and between a detection continuous phase inlet and a detection continuous phase channel.
